(19) United States
(12) Patent Application Publication
(10) Pub. No.: US 2011/0037395 A1
(43) Pub. Date: Feb. 17, 2011

(54) VEHICLE HAVING A SOLAR-POWERED LIGHT EMITTING DEVICE

(76) Inventors: Chung-Hsu Kao, Tainan City (TW); Yi-Ming Hsu, Taipei City (TW)

Correspondence Address: SHOOK, HARDY & BACON LLP;INTELLECTUAL PROPERTY DEPARTMENT, 2555 GRAND BLVD, KANSAS CITY, MO, 64108-2613, US

(21) Appl. No.: 12/539,775

(22) Filed: Aug. 12, 2009

(51) Int. Cl. H05B 41/36

(52) U.S. Cl. 315/150; 362/183

(57) ABSTRACT

A vehicle includes a vehicle body and a solar-powered light emitting device. The solar-powered light emitting device includes a hollow base, a light emitting unit, a light guide element, a power supply unit, and a control unit. The hollow base is disposed on a lateral side of the vehicle body, confines a receiving space, and is formed with a light exit in spatial communication with the receiving space. The light emitting unit includes a control board and a light emitting element. The light guide element is disposed on the hollow base outwardly of the receiving space, and is disposed to receive the light passing through the light exit. The power supply unit includes a solar cell and a rechargeable battery unit. The control unit is coupled electrically to the rechargeable battery unit and the light emitting unit, and includes a light sensor and a vibration sensor.

### BACKGROUND OF THE INVENTION

1. Field of the Invention

The present invention relates to a vehicle, more particularly to a vehicle having a solar-powered light emitting device.

2. Description of the Related Art

Currently, a vehicle is mounted with illuminating lamps or warning lamps, such as headlamps, fog lamps, signal lamps, and so on, at front and rear sides of the vehicle itself, so as to achieve the effect of illuminating and warning and reduce the probability of traffic accidents due to poor visibility.

However, the illuminating or warning lamps at front and rear sides of the vehicle may only warn people in front of and behind the vehicle. That is, the effect of illuminating or warning relative to sides of the vehicle is limited.

Referring to FIG. 1, Taiwanese Publication No. 545415 discloses a light-emitting vehicle edging strip which comprises an edging strip body 11 mounted on a predetermined position of a vehicle door 100, a transparent mask 12 disposed on the edging strip body 11, and a plurality of light emitting elements 13 (only one is shown in FIG. 1) that are disposed on the edging strip body 11 and that face toward one side of the transparent mask 12.

By mounting the edging strip body 11 on the predetermined position of the vehicle door 100, and by activating the light emitting elements 13 to emit light toward the transparent mask 12, a warning effect for people around sides of the vehicle may be achieved. However, the light emitting elements 13 require use of an additional power source, such as a dry cell or a rechargeable battery, or electrical power of the vehicle to emit the light. Since residual power of the additional power source is not easy to control, a condition of insufficient electrical power often occurs, which affects the effect of the vehicle edging strip 1 for warning pedestrians. Furthermore, utilizing electrical power of the vehicle not only necessitates a wired connection, which is difficult to implement and can damage the structure of the vehicle, but also increases an electrical power load of the vehicle, which can affect operations of headlamps, signal lamps, other vehicle devices, and soon due to insufficient electrical power.

### SUMMARY OF THE INVENTION

Therefore, the object of the present invention is to provide a vehicle having a solar-powered light emitting device for improving driving safety.

Accordingly, a vehicle of the present invention comprises a vehicle body and a solar-powered light emitting device. The solar-powered light emitting device includes a hollow base, a light emitting unit, a light guide element, a power supply unit, and a control unit. The hollow base is disposed on a lateral side of the vehicle body, confines a receiving space, and is formed with a light exit in spatial communication with the receiving space. The light emitting unit includes a control board disposed in the receiving space, and a light emitting element disposed on the control board and operable to emit light that passes through the light exit. The light guide element is disposed on the hollow base outwardly of the receiving space, and is disposed to receive the light passing through the light exit. The power supply unit includes a solar cell disposed on the hollow base outwardly of the receiving space and operable to convert solar energy into electrical energy, and a rechargeable battery unit electrically connected to the solar cell for storing the electrical energy from the solar cell. The control unit is coupled electrically to the rechargeable battery unit and the light emitting unit, and includes a light sensor for sensing ambient light and a vibration sensor for sensing vibration of the hollow base due to vibration of the vehicle body. The control unit enables supply of electrical power from the rechargeable battery unit to the light emitting unit when the ambient light detected by the light sensor is insufficient and vibration of the hollow base is detected by the vibration sensor.

According to another aspect of the present invention, a solar-powered light emitting device comprises a hollow base, a light emitting unit, a light guide element, a power supply unit, and a control unit. The hollow base confines a receiving space, and is formed with a light exit in spatial communication with the receiving space. The light emitting unit includes a control board disposed in the receiving space, and a light emitting element disposed on the control board and operable to emit light that passes through the light exit. The light guide element is disposed on the hollow base outwardly of the receiving space, and is disposed to receive the light passing through the light exit. The power supply unit includes a solar cell disposed on the hollow base outwardly of the receiving space and operable to convert solar energy into electrical energy, and a rechargeable battery unit electrically connected to the solar cell for storing the electrical energy from the solar cell. The control unit is coupled electrically to the rechargeable battery unit and the light emitting unit, and includes a light sensor for sensing ambient light and a vibration sensor for sensing vibration of the hollow base. The control unit enables supply of electrical power from the rechargeable battery unit to the light emitting unit when the ambient light detected by the light sensor is insufficient and vibration of the hollow base is detected by the vibration sensor.

### BRIEF DESCRIPTION OF THE DRAWINGS

Other features and advantages of the present invention will become apparent in the following detailed description of the preferred embodiments with reference to the accompanying drawings, of which:

FIG. 1 is a sectional view to illustrate a conventional light-emitting vehicle edging strip according to Taiwanese Publication No. 545415;

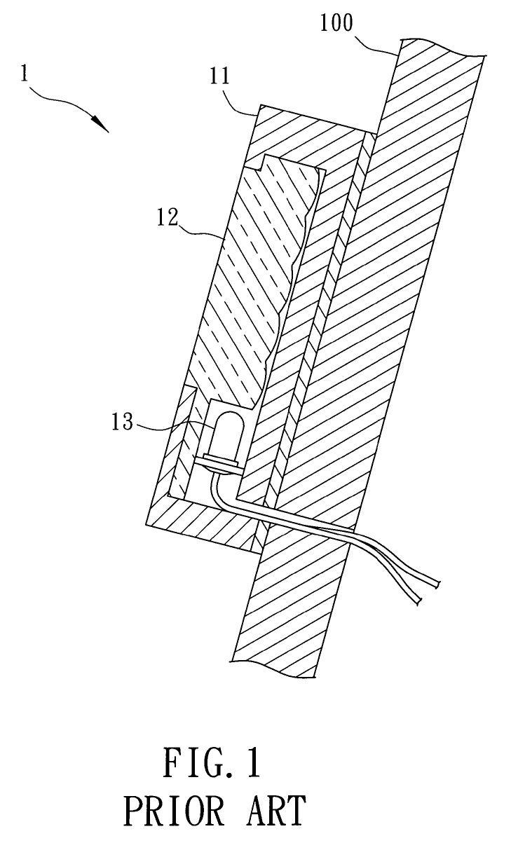

FIG. 2 is a front perspective view of a first preferred embodiment of a vehicle having a solar-powered light emitting device according to the present invention;

FIG. 3 is a sectional view of the solar-powered light emitting device of the first preferred embodiment;

FIG. 4 is a schematic circuit block diagram of the first preferred embodiment to illustrate connections among a control unit, a light emitting unit, and a power supply unit; and

FIG. 5 is a sectional view of a second preferred embodiment of a vehicle having a solar-powered light emitting device according to the present invention.

### DETAILED DESCRIPTION OF THE PREFERRED EMBODIMENTS

Before the present invention is described in greater detail, it should be noted that like components are assigned the same reference numerals throughout the following disclosure.

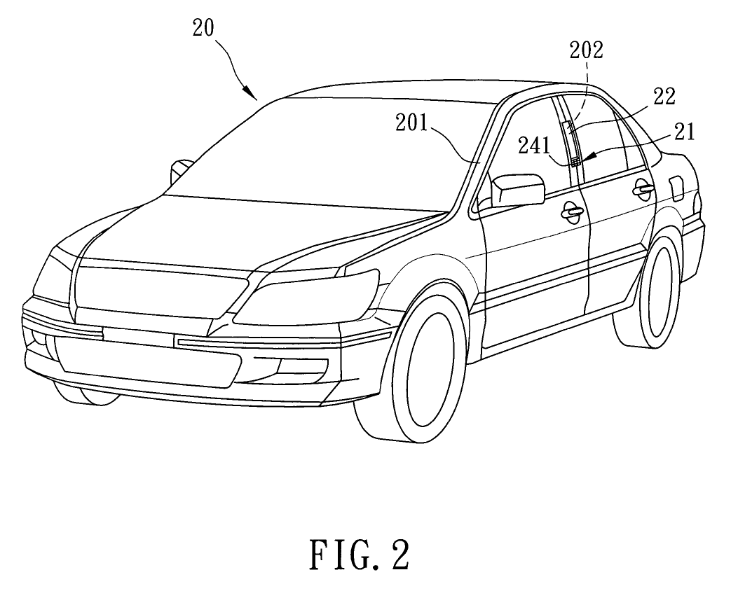

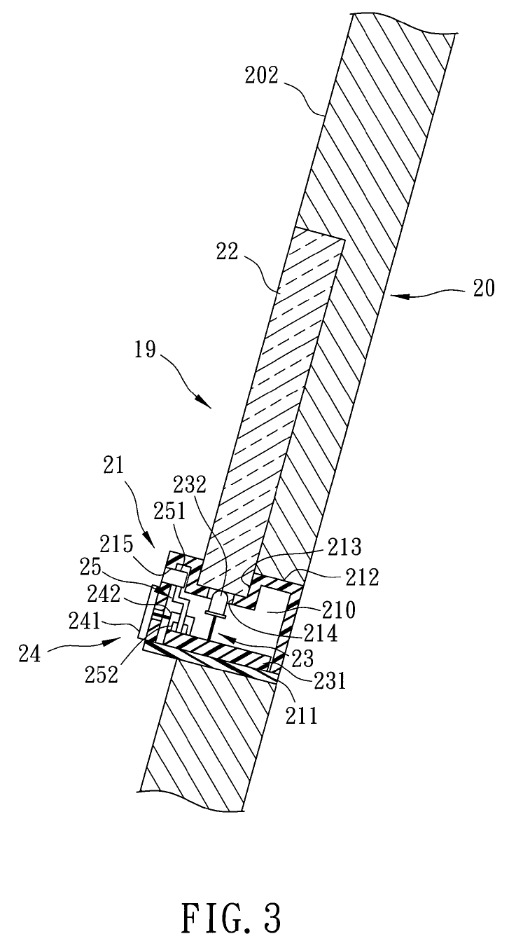

Referring to FIGS. 2 and 3, the first preferred embodiment of a vehicle according to the present invention is shown to comprise a vehicle body 20 and a solar-powered light emitting device 19. The vehicle body 20 includes a front pillar 201 and a center pillar 202 that is at a lateral side of the vehicle body 20 and that is spaced apart from the front pillar 201. The solar-powered light emitting device 19 includes a hollow base 21, a light emitting unit 23, a light guide element 22, a power supply unit 24, and a control unit 25.

The hollow base 21 is disposed on the center pillar 202 at the lateral side of the vehicle body 20, and includes a bottom plate 211 mounted in the center pillar 202 and a cover 212 that covers the bottom plate 211 and that cooperates with the bottom plate 211 to confine a receiving space 210. The cover 212 of the hollow base 21 is formed with an insert groove 213 and a detection hole 215 that is in spatial communication with the receiving space 210. The insert groove 213 has a groove wall formed with a light exit 214 that is in spatial communication with the receiving space 210. The light emitting unit 23 includes a control board 231 disposed in the receiving space 210 and on the bottom plate 211, and a light emitting element 232 that is disposed on the control board 231 and that is operable to emit light passing through the light exit 214. In this preferred embodiment, the light emitting element 232 is a light emitting diode (LED) that extends into the light exit 214. The light guide element 22 is disposed on the hollow base 21 outwardly of the receiving space 210, and is disposed to receive the light passing through the light exit 214. In this embodiment, the light guide element 22 extends removably into the insert groove 213 such that the light emitting element 232 faces toward a lateral edge of the light guide element 22.

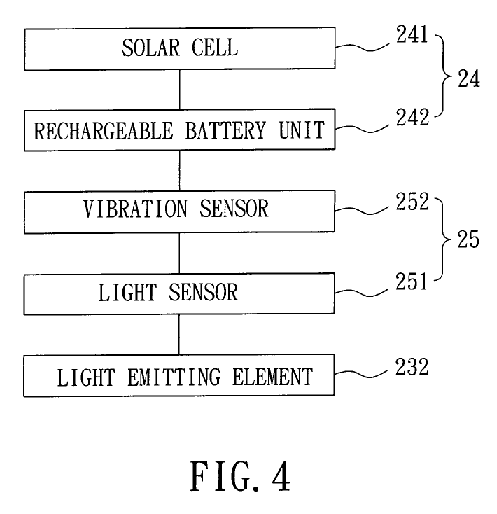

Referring to FIGS. 3 and 4, the power supply unit 24 includes a solar cell 241 that is disposed on an outer lateral side of the cover 212 of the hollow base 21 outwardly of the receiving space 210 and that is operable to convert solar energy into electrical energy, and a rechargeable battery unit 242 that is deposed in the receiving space 210 and that is electrically connected to the solar cell 241 for storing the electrical energy from the solar cell 241. The light guide element 22, the solar cell 241, and the detection hole 215 are exposed from the center pillar 202. The control unit 25 is coupled electrically to the rechargeable battery unit 242 and the light emitting unit 23, and includes a light sensor 251 for sensing ambient light through the detection hole 215, and a vibration sensor 252 for sensing vibration of the hollow base 21 due to vibration of the vehicle body 20. In this embodiment, the light sensor 251 is electrically connected to the light emitting element 232 of the light emitting unit 23. The vibration sensor 252 is electrically connected to the light sensor 251 and the rechargeable battery unit 242. The light sensor 251 and the vibration sensor 252 are disposed in the receiving space 210 and are disposed on the control board 231. In this preferred embodiment, the light sensor 251 includes a photoresistor, the vibration sensor 252 includes a vibration switch, and the control board 231 is a circuit board.

When ambient light is sufficient, the solar cell 241 converts solar energy into electrical energy for storage in the rechargeable battery unit 242. The light sensor 251 detects the sufficient ambient light via the detection hole 215 and is thus in a non-conducting state, so as to disable supply of electrical power from the rechargeable battery unit 242 to the light emitting element 232. This mechanism avoids activating the light emitting element 232 when there is sufficient ambient light, and reduces waste of electrical power stored in the rechargeable battery unit 242.

When the ambient light detected by the light sensor 251 via the detection hole 215 is insufficient, the light sensor 251 switches to a conducting state. However, if the vehicle does not move, i.e., vibration of the hollow base 21 is not detected by the vibration sensor 252, the vibration sensor 252 remains in a non-conducting state to disable supply of electrical power from the rechargeable battery unit 242 to the light emitting element 232. This mechanism avoids activating the light emitting element 232 when the vehicle is motionless at night, and reduces waste of electrical power stored in the rechargeable battery unit 242.

Furthermore, when the ambient light detected by the light sensor 251 is insufficient and vibration of the hollow base 21 is detected by the vibration sensor 252, the light sensor 251 and the vibration sensor 252 of the control unit 25 both conduct so as to enable supply of electrical power from the rechargeable battery unit 242 to the light emitting element 232 of the light emitting unit 23. The light emitting element 232 receives the electrical power from the rechargeable battery unit 242, and emits light toward the lateral edge of the light guide element 22 such that the light guide element 22 mounted on the center pillar 202 emits light to warn people from the lateral side of the vehicle. Thus, safety when driving a vehicle can be improved.

The vehicle uses the solar cell 241 to transform solar energy into electrical power for storage in the rechargeable battery unit 242, which then provides the electrical power to the light emitting element 232. Accordingly, the light emitting element 232 can acquire sufficient power, and stability and service lifetime of the light emitting element 232 can be improved. Furthermore, by virtue of the light sensor 251 and the vibration sensor 252 of the control unit 25, the light emitting element 232 is activated only when ambient light is insufficient and vibration attributed to driving a vehicle occurs. This mechanism not only can avoid waste of electrical power stored in the rechargeable battery unit 242 but also allows light to be emitted from the light guide element 22 to warn people from a lateral side of the vehicle when appropriate, which enhances driving safety.

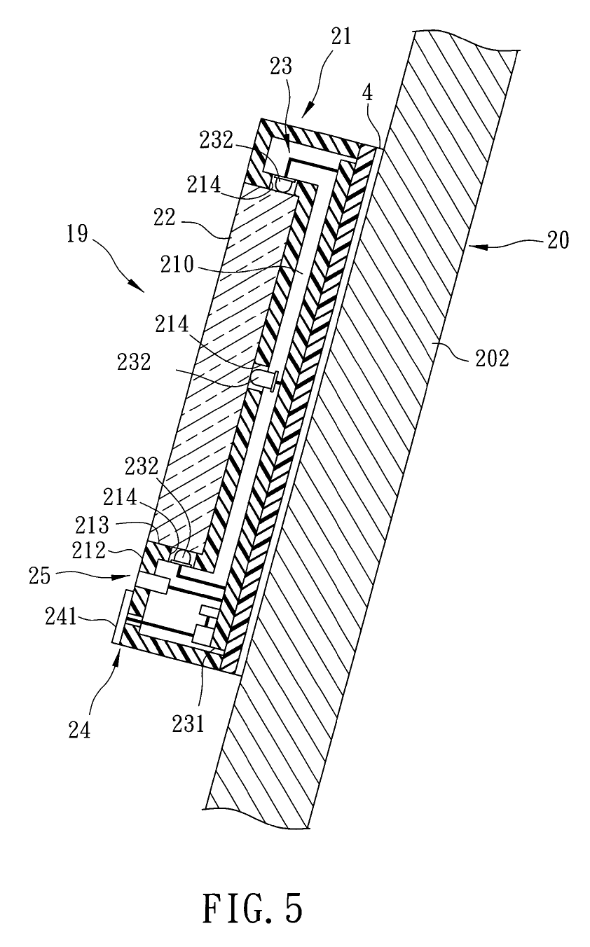

Referring to FIG. 5, a second preferred embodiment of a vehicle having a solar-powered light emitting device of the present invention is shown to be similar to the first preferred embodiment. The second preferred embodiment differs from the first preferred embodiment in the following aspects. The insert groove 213 is formed with a plurality of light exits 214 in spatial communication with the receiving space 210. In addition, the light emitting unit 23 includes a plurality of light emitting elements 232 that are disposed on the control board 231 and that face toward the corresponding light exits 214. Furthermore, the hollow base 21 is attracted to and is attached on the center pillar 202 of the vehicle body 20 using a magnet 4.

In this preferred embodiment, the hollow base 21 uses the magnet 4 for attaching on the center pillar 202. In other embodiments, the hollow base 21 of the solar-powered light emitting device 19 may use screws, adhesive, or other manners for attaching on the center pillar 202 of vehicle body 20.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A vehicle comprising:
a vehicle body; and
a solar-powered light emitting device including
a hollow base that is disposed on a lateral side of said vehicle body, that confines a receiving space, and that is formed with a light exit in spatial communication with said receiving space,
a light emitting unit including a control board disposed in said receiving space, and a light emitting element disposed on said control board and operable to emit light that passes through said light exit,
a light guide element disposed on said hollow base outwardly of said receiving space, and disposed to receive the light passing through said light exit,
a power supply unit including a solar cell disposed on said hollow base outwardly of said receiving space and operable to convert solar energy into electrical energy, and a rechargeable battery unit electrically connected to said solar cell for storing the electrical energy from said solar cell, and
a control unit coupled electrically to said rechargeable battery unit and said light emitting unit, said control unit including a light sensor for sensing ambient light and a vibration sensor for sensing vibration of said hollow base due to vibration of said vehicle body, said control unit enabling supply of electrical power from said rechargeable battery unit to said light emitting unit when the ambient light detected by said light sensor is insufficient and vibration of said hollow base is detected by said vibration sensor.

2. The vehicle as claimed in claim 1, wherein said vehicle body includes a center pillar at said lateral side thereof, said hollow base being disposed on said center pillar.

3. The vehicle as claimed in claim 1, wherein said hollow base is formed with an insert groove, said light guide element extending removably into said insert groove.

4. The vehicle as claimed in claim 3, wherein said insert groove has a groove wall formed with said light exit, said light emitting element extending into said light exit.

5. The vehicle as claimed in claim 1, wherein said hollow base is formed with a detection hole, said light sensor and said vibration sensor are disposed in said receiving space, and said light sensor detects ambient light through said detection hole.

6. The vehicle as claimed in claim 1, wherein said vibration sensor includes a vibration switch, and said light sensor includes a photoresistor.

7. The vehicle as claimed in claim 1, wherein said light emitting element is a light emitting diode, said control board is a circuit board, and said vibration sensor and said light sensor are disposed on said control board.

8. A solar-powered light emitting device comprising:
a hollow base that confines a receiving space, and that is formed with a light exit in spatial communication with said receiving space;
a light emitting unit including a control board disposed in said receiving space, and a light emitting element disposed on said control board and operable to emit light that passes through said light exit;
a light guide element disposed on said hollow base outwardly of said receiving space, and disposed to receive the light passing through said light exit;
a power supply unit including a solar cell disposed on said hollow base outwardly of said receiving space and operable to convert solar energy into electrical energy, and a rechargeable battery unit electrically connected to said solar cell for storing the electrical energy from said solar cell; and
a control unit coupled electrically to said rechargeable battery unit and said light emitting unit, said control unit including a light sensor for sensing ambient light and a vibration sensor for sensing vibration of said hollow base, said control unit enabling supply of electrical power from said rechargeable battery unit to said light emitting unit when the ambient light detected by said light sensor is insufficient and vibration of said hollow base is detected by said vibration sensor.

9. The solar-powered light emitting device as claimed in claim 8, wherein said hollow base is formed with an insert groove, said light guide element extending removably into said insert groove.

10. The solar-powered light emitting device as claimed in claim 9, wherein said insert groove has a groove wall formed with said light exit, said light emitting element extending into said light exit.

11. The solar-powered light emitting device as claimed in claim 8, wherein said hollow base is formed with a detection hole, said light sensor and said vibration sensor are disposed in said receiving space, and said light sensor detects ambient light through said detection hole.

12. The solar-powered light emitting device as claimed in claim 8, wherein said vibration sensor includes a vibration switch, and said light sensor includes a photoresistor.

13. The solar-powered light emitting device as claimed in claim 8, wherein said light emitting element is a light emitting diode, said control board is a circuit board, and said vibration sensor and said light sensor are disposed on said control board.
